(19) United States
(12) Patent Application Publication
(10) Pub. No.: US 2007/0011654 A1
(43) Pub. Date: Jan. 11, 2007

(54) Method and apparatus for reformatting source code appearance

(76) Inventor: David B. Opperman, Beaverton, OR (US)

Correspondence Address: LAW OFFICES OF MICHAEL DRYJA, 704 228TH AVE NE, #694, SAMMAMISH, WA, 98074, US

(21) Appl. No.: 11/178,870

(22) Filed: Jul. 10, 2005

(51) Int. Cl. G06F 9/44

(52) U.S. Cl. 717/122

(57) ABSTRACT

The appearance formats, or coding styles, of source code files are reformatted. Specifically, a source code file is reformatted from a first appearance format to a second appearance format, with the source code of the file remaining substantively unchanged, upon the file being checked out from a source code repository. The source code file is reformatted from the second appearance format back to the first appearance format, with the source code remaining substantively unchanged, upon the file being checked back into the source code repository. Before reformatting, it may be determined whether a flag of the source code file indicates that it has been checked out in a read-only manner. If so, the flag is changed so that the source code file can be modified. After the file has been reformatted, the flag is changed back to again indicate that the file has been checked out in a read-only manner.

### FIELD OF THE INVENTION

The present invention relates generally to source code files that are used to develop executable computer programs, and more particularly to reformatting the appearance, or coding style, of such source code files.

### BACKGROUND OF THE INVENTION

Source code includes programming statements and instructions that are written by a programmer in accordance with a given computer programming language, such as C++, Java, or another type of computer programming language. A programmer writes source code, but the source code is not directly executable by a computing system. Rather, the source code is first converted into object code or executable code by a compiler, an assembler, or an interpreter.

Source code is typically developed within integrated development environments (IDE's) or other software development tools. An IDE enables a computer programmer to write and edit source code, and also may allow the programmer to compile, or convert, the source code into object code or executable code, which can then be tested. IDE's may also include debugging tools so that a programmer can diagnose source code that is not performing as expected, as well as provide other functionality.

Different programmers prefer different coding styles. A coding style is the manner in which source code is displayed. That is, a coding style has to do with the appearance of the source code. A coding style does not affect how the source code is converted into object or executable code. Two source code files can be generated that are otherwise identical except for their coding styles. Thus, the coding style is intended for the programmer, so that the programmer is able to view the source code in way that he or she prefers the appearance of the source code to be.

For instance, the manner by which corresponding lines are indented in source code is part of a coding style, as is how opening and closing braces are employed. The two sections of source code, for example, have different coding styles, even though they are otherwise identical and convert into the same object or executable code.

```
while (flag == true) do {
    statement 1; }
end;
while (flag == true) do
  {
    statement 1;
  }
end;
```

In the first section of code, the opening brace, “{”, is placed on the same line as the “while . . . do” statement is, immediately after the “do” part of the statement, whereas in the second section of code, the opening brace is placed on its own line. Similarly, in the first section of code, the closing brace, “}”, is placed on the same line as “statement 1”, whereas in the second section of code, the closing brace is place on its own line. Furthermore, in the first section of code, a tab is used to indent “statement 1”, whereas in the second section of code, spaces are used for indenting, such that “statement 1” is farther inward of the “while . . . do” statement in the first section of source code as compared to in the second section of source code.

While these two example sections of code have different appearances, they represent the same programming statements, and will compile to the same object or executable code. Coding styles, in other words, have to do with the appearance of the source code, and are personal preferences of programmers. One programmer may prefer a more compact display of code, and thus prefer to use the coding style of the first section of code displayed above, whereas another programmer may prefer a more expansive display of code, and prefer to use the coding style of the second section of code.

In modern computer-programming projects, it is common for many computer programmers to work on the same project. For instance, each programmer may be assigned to develop the source code for a different part of the project. However, programmers may be asked to review the source code developed by other programmers, and programmers may be reassigned so that the one programmer starts developing the source code for a part of the project, and another programmer finishes developing the source code for this part of the project. In other words, there are many instances where the source code developed by one programmer has to be reviewed, modified, or worked on by other programmers.

To facilitate many computer programmers working on the same computer-programming project, a source code repository is often use to track who is working on which part of the project, and to ensure that a given source code file is being updated by just one programmer. A source code repository thus is the mechanism by which a number of source code files are stored. The programmer of each source code file may be identified in the repository. If a programmer wishes to view a source code file, he or she checks out a read-only version of the source code file, such that the repository is aware of who is currently viewing which source code files. If a programmer wishes to modify a source code file, he or she checks out a modifiable version of the source code file. At any one time, a given source code file may have read-only versions checked out by multiple programmers, but may only have one modifiable version checked out. In some types of source code repositories, however, multiple modifiable versions can be checked out, where they are merged together when checked back into the source code repository.

Computer-programming projects that utilize source code repositories may have coding styles employed in one of two different ways. First, each programmer may be permitted to develop source code in accordance with his or her own personally preferred coding style. The result is that the source code files stored in the source code repository may represent a mishmash of different coding styles, and not a unified coding style for all of the source code files of a given project. Second, each programmer may be requested to develop source in accordance with a standard set of coding styles for the project, so that there is a unified coding style for all of the source code files for the project.

In either case, a programmer may have to view and/or develop source code that has a coding style other than what he or she prefers. In the first case, a programmer may be asked to modify or review a source code file developed by another programmer who prefers a different coding style. In the second case, a programmer may prefer a coding style that is different than the standard coding style for the computer-programming project in question. At best, forcing a programmer to view and/or develop source code in a different coding style than what he or she prefers is inconvenient for the programmer.

At worst, however, forcing a programmer to view and/or develop source code in a different coding style than what he or she prefers can affect efficiency as well as source code quality. For example, a programmer may not be accustomed to a given coding style, making it difficult for him or her to understand the source code developed in that style, or to develop source code in that style. Furthermore, a programmer who is not accustomed to a given coding style may be more likely to make mistakes when developing source code in that style, which affects the quality of the resulting code. In addition, source code files may be stored in a source code repository in multiple different coding styles, instead of in a uniform coding style that may be preferred.

For these and other reasons, therefore, there is a need for the present invention.

### SUMMARY OF THE INVENTION

The present invention relates to reformatting the appearance format, or coding style, of source code files. A method of the invention reformats a source code file from a first appearance format to a second appearance format, with the source code of the source code file remaining substantively unchanged, upon the source code file being checked out from a source code repository. The method further reformats the source code file from the second appearance format back to the first appearance format, with the source code remaining substantively unchanged, upon the source code file being checked back into the source code repository.

Before reformatting the source code file, the method may determine whether a flag of the source code file indicates that the file has been checked out in a read-only manner. If so, the method changes the flag of the source code file so that the file can be modified before reformatting the source code file. After the source code file has been reformatted, the flag of the source code file is changed back to indicate that the file has been checked out in a read-only manner.

A system of the invention includes a source code repository, one or more software development tools, and a filtering mechanism. The source code repository is to store one or more source code files. The software development tools are each capable of checking out the source code files from and checking the source code files back into the source code repository. The filtering mechanism is to reformat the source code files from a first appearance format to a second appearance format upon the source code files being checked out, and to reformat the source code files from the second appearance format back to the first appearance format upon the source code files being checked back into the source code repository. The filtering mechanism may be part of and integrated with the software development tools, or it may be a stand-alone mechanism separate from the software development tools. Alternatively, the filtering mechanism may be integrated within the source code repository itself.

An article of manufacture of the invention includes a computer-readable medium and means in the medium. The medium may be a recordable data storage medium, a modulated carrier signal, or another type of computer-readable medium. The means is for reformatting a source code file from a first appearance format to a second appearance format upon the file being checked out from a source code repository, and for reformatting the source code file from the second appearance format back to the first appearance format upon the file being checked back into the source code repository.

Embodiments of the invention provide for advantages over the prior art. A programmer, when checking out a source code file from a source code repository that is in a different appearance format, or coding style, than his or her preferred appearance format, or coding style, is able to have the file automatically reformatted as desired. When the source code file is checked back in, the source code file is reformatted back to the original appearance format, or coding style.

Therefore, the invention provides for a source code repository being able to store source code files so that they all have the same appearance format, or coding style, while still allowing programmers to view and modify the files in accordance with their own preferred appearance formats, or coding styles. More generally, the invention allows a given programmer to always view and modify source code files in a preferred appearance format, regardless of the original appearance formats in which the source code files have been created. As such, programmers may more conveniently view and modify source code files, are likely to be more efficient, and may make less coding mistakes, than if they are required to view and modify such files without being able to automatically modify the appearance formats, or coding styles, of the files, as in the prior art.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of the example reformatting of a rudimentary source code file from one appearance format to another appearance format, according to an embodiment of the invention.

FIG. 2 is a diagram of a system having a software development tool that is able to accomplish source code file appearance format reformatting, according to an embodiment of the invention, and is suggested for printing on the first page of the patent.

FIG. 3 is a diagram of a system in which a filtering mechanism separate from a software development tool reformats the appearance formats of source code files as they are checked out from a source code repository into the tool and checked back into the source code repository from the tool, according to an embodiment of the invention.

FIG. 4 is a flowchart of a method to reformat a source code file from one appearance format to another appearance format, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

Embodiments of the invention reformat a source code file from one appearance format, or coding style, to another appearance format, or coding style, without substantively changing source code of the source code file. A source code file is a human-readable text file that contains source code. Source code includes programming statements and instructions that are written by a programmer in accordance with a given computer programming language, such as C++, Java, or another type of computer programming language. A programmer writes source code, but the source code is not directly executable by a computing system. Rather, the source code is first converted into object, executable, or other compiled code by a compiler, an assembler, or an interpreter.

An appearance format, or coding style, is the manner in which the source code of the source code file is created and displayed. That is, the appearance format of the source code file has to do with the appearance, or style, of the source code when created and displayed. The appearance format does not affect how the source code of the file is converted into object, executable, or other compiled code. In other words, changing the appearance format of a source code file does not substantively change the source code of the file, in that the source code of the file is compilable into the same, or identical, compiled code independent or regardless of whether the source code file is formatted in accordance with a given appearance format or coding style.

Different types of appearance-related aspects are encompassed by the appearance format of a source code file. Such appearance-related aspects can include the spacing used in the source code file, such as the number of spaces or tabs used, and whether spaces or tabs are used, in separating different logical portions of the source code of the file, for indenting and other purposes. The aspects may include the maximum line length of each line of the source code of the source code file, and how that maximum line length is achieved. For instance, a given source code file may have lines ranging up to 120 characters. If the desired maximum line length is 80 characters, the additional 40 characters of each such line within the source code file may be moved to a different line in a number of different ways. As one example, all the characters beyond the first 80 characters may be moved to a new line. As another example, all the characters past the closest space to the 80^{th} character may be moved to a new line, similar to how wrap-wrap functionality is achieved in word-processing programs.

Appearance-related aspects can further include the placement of opening and closing braces used in loop-type programming constructs, such as repeat/until, for/end, and while/end constructs, among others. Some programmers may want these braces to appear on their own lines, for example, whereas other programmers may want these braces to appear on lines with other programming statements. Appearance-related aspects can also include how color is used in a source code file. The commands of a computer-programming language may appear in one color, for example, whereas user-defined variables and constants may appear in another color. In general, anything have to do with the appearance of the source code of a source code file can be considered to be an appearance-related aspect of the appearance format, or coding style, of the source code file. The terminology appearance format is used interchangeably and synonymously with the terminology coding style herein.

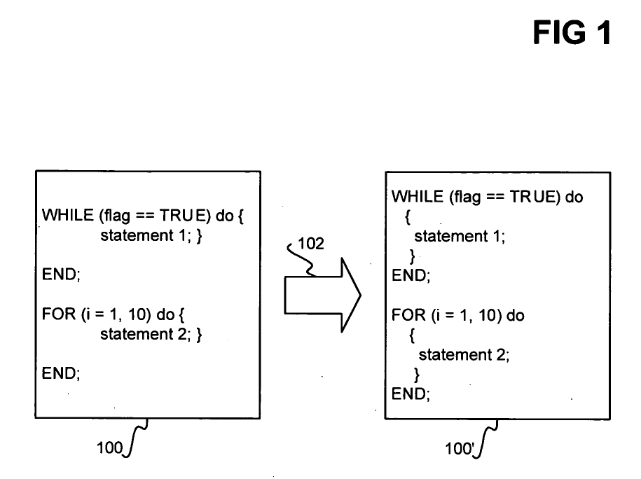

FIG. 1 shows an example reformatting of the source code of a rudimentary source code file from one appearance format to another appearance format, according to an embodiment of the invention. The source code file 100 contains source code of a pseudo-code nature for example purposes, which looks like C++ or Java programming language code, but is not exactly C++ or Java code. As can be appreciated by those of ordinary skill within the art, typically the source code file 100 will contain much more source code than that which is depicted in FIG. 1, and the particular pseudo-source code is depicted therein for illustrative and descriptive convenience. The source code file 100 has a particular appearance format, such that opening and closing braces are placed on the same lines with other programming statements. Furthermore, the statements within the loop-type “while . . . end” and “for . . . end” structures are indented using tabs.

The source code file 100 is reformatted in accordance with another appearance format, as indicated by the arrow 102, such that after reformatting the source code file 100 is denoted as the source code file 100′ in FIG. 1. The source code file 100′ has a different particular appearance format. The opening and closing braces are placed on separate lines as compared to other programming statements, in contradistinction to the source code file 100 prior to reformatting. Furthermore, the statements within the loop-type “while . . . end” and “for . . . end” structures indented with spaces, instead of using tabs, in contradistinction to the source code file 100 prior to reformatting.

Reformatting the source code file 100 from one appearance format to another appearance format is accomplished by parsing the source code of the file 100, character-by-character and line-by-line. As text is encountered in a given appearance format, it is changed in accordance with a different appearance format. For example, in FIG. 1, when each of the opening and closing braces “{” and “}” is encountered on the same line as other programming statements, a carriage return and or linefeed is added prior to the brace in question, and two spaces of indenting are added. As another example, also in FIG. 1, when a tab is encountered, such as before “statement1;” and before “statement2;”, the tab is replaced by four spaces of indenting.

Therefore reformatting the source code file 100 does involve changing the source code file 100 in one embodiment of the invention. However, the source code file 100 is not substantively changed, as has been noted. That is, the source code file 100 before reformatting and the source code file 100′ after reformatting will compile to the same compiled code. This is because reformatting the source code file 100 does change the actual source code of the file 100, but just changes how the source code of the file 100 is displayed. This is why it can be said that the source code file 100 is not substantively changed, because the substance of the file 100 is not changed as a result of reformatting. Rather, just the appearance of the source code within the source code file 100 is modified or changed as a result of reformatting.

It is also noted that a source code file 100 inherently has an appearance format associated therewith, by virtue of creation of the source code of the source code file 100. That is, the appearance format of the source code file 100 is not a separate set of appearance-related preferences associated with or part of the file 100, in one embodiment of the invention. Rather, the appearance format of the source code file 100 is particularly the manner in which the source code appears within the source code file 100. For example, in FIG. 1, in generating the source code file 100, a programmer or an automated source code generator added the opening brace “{” on the first line after inserting a space after the programming statement “do”.

By virtue of adding this brace at this location, the programmer or automated source code generator generated the source code of the source code file 100 in accordance with a particular appearance format. There is no separate set of appearance-related preferences that is associated with or is part of the source code file 100, in this embodiment. The hard entry of where various programming and other statements are added to the source code file 100 denotes the appearance format of the source code file 100. This is why changing or reformatting the source code file 100 into a different appearance format or code style does change the format of the source code of the file 100, albeit not substantively. It is noted that the source code file 100 may originally not be formatted consistently, such that its initial appearance format encompasses a number of different coding styles. That is, the source code file 100 may not have been formatted in accordance with any given coding style, and may indeed have been formatted in accordance with a number of different coding styles, such that the source code file 100 is not consistently formatted. As a result, the initial appearance format of the source code file 100 is said to encompass a number of different coding styles. Furthermore, in another embodiment of the invention, some of the appearance-related preferences for the source code file 100 may be stored as metadata, either within the file 100 or within a separate metadata file.

Systems and Technical Background

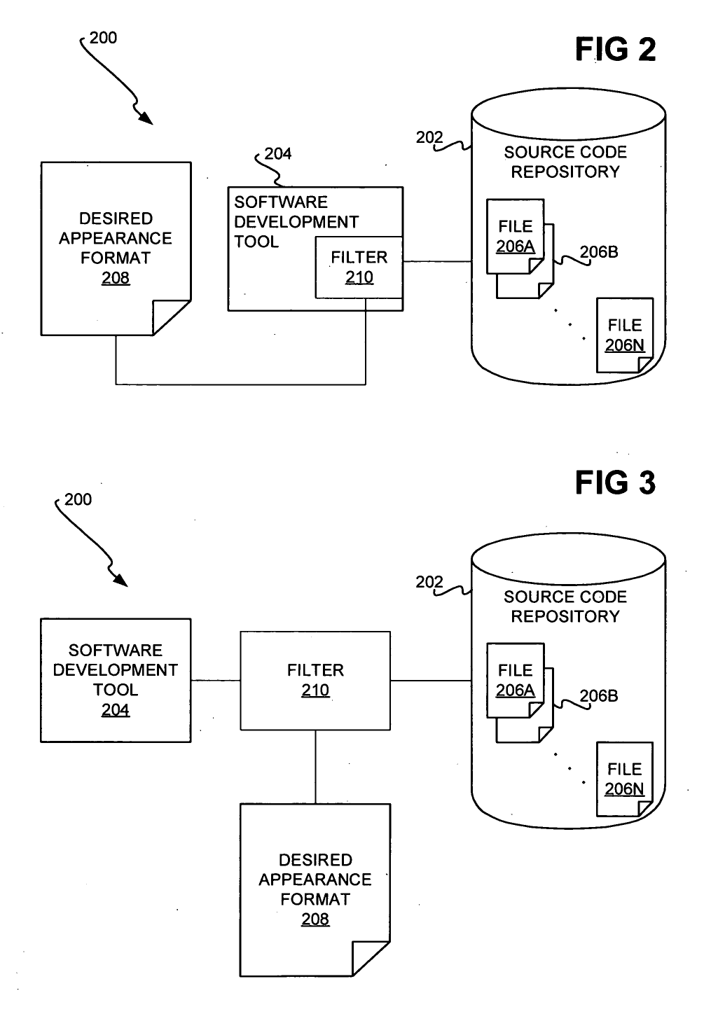

FIGS. 2 and 3 show a system 200 within which appearance format reformatting of source code files can be achieved, according to different embodiments of the invention. In both FIGS. 2 and 3, the system 200 includes a source code repository 202, a software development tool 204, and a filtering mechanism 210. While just one software development tool 204 is depicted, in other embodiments there may be more than one software development tool. The software development tool 204 and the filtering mechanism 210 may each be implemented in software, hardware, or a combination of software and hardware. The software development tool 204 may be or may not be part of an integrated development environment (IDE), which may also contain compilers, interpreters, debuggers, and so on, which are not specifically depicted in FIGS. 2 and 3.

The source code repository 202 contains a number of source code files 206A, 206B, . . . , 206N, which are collectively referred to as the source code files 206. The source code repository 202 may include the actual storage device, such as a hard disk drive, on which the source code files 206 are stored, and may further include versioning and other functionality to accommodate multiple-programmer access to the source code files 206. In another embodiment, however, the source code repository 202 may simply be or include the file-handling system of the operating system within which the software development tool 204 is running.

The source code files 206 may in one embodiment be related to one another, such as of the same type and/or as part of the same programming project. As has been described, each of the source code files 206 inherently has a preexisting appearance format, or coding style, at least by virtue of the generation of the source code within the source code files 206. In one embodiment, the source code files 206 may all have the same appearance format, where, for instance the files 206 were generated by the same programmer or automated source code generator, or the files 206 were generated by different programmers adhering to the same appearance format or coding style.

In FIG. 2 specifically, the filtering mechanism 210 is integrated with and part of the software development tool 204, such that it can be considered that the software development tool 204 performs the functionality of the filtering mechanism 210 in one embodiment. The filtering mechanism 210 has an associated desired appearance format 208. The appearance format 208 is the appearance format or coding style selected by the programmer using the software development tool 204, as the appearance format with which the programmer wishes to view, modify, and create source code. For example, the software development tool 204 may have the capability of allowing a programmer to select options or values for different appearance-related aspects that make up the desired appearance format 208, such as whether tabs or spaces or used for indents, the number of tabs or spaces, and so on. The software development tool 204 may further have the capability to store a number of different appearance formats, in addition to the appearance format 208, for the same or different programmers, so that different appearance formats can be selected.

A programmer using the software development tool 204 who wishes to view or modify one of the source code files 206 checks out such a selected source code file from the source code repository 202 through the software development tool 204. If the programmer just wants to view the selected source code file, he or she checks out a read-only version of the file, whereas if the programmer wants to modify the selected source code file, he or she checks out a modifiable version of the file. The difference is that multiple programmers may be able to concurrently check out read-only versions of the same source code file. By comparison, only one programmer may be able to check out a modifiable version of the same source code file at a given time, to avoid programmers making conflicting changes to the file. However, in some embodiments, multiple programmers may each be able to check out a modifiable version of the same source code file at the same time, where the versions are merged together when checked back in. Furthermore, a programmer may not be able to check out a modifiable version of a source code file if other programmers have already checked out read-only versions of the file, to avoid outdating the read-only versions of the file that the other programmers have checked out.

In one embodiment, each of the source code files 206 may have an associated flag or other identifier indicating whether a checked-out version of that source code file is read-only or modifiable. These flags or identifiers may be in accordance with the host operating system within which the software development tool 204 and the source code repository 202 are running. For example, the flags or identifiers may be one or more permission bits that indicate how a given source code file is to be used, such as whether the source code file is read-only, or whether changes may be made to the source code file.

Upon checking out the selected source code file from the source code repository 202 through the software development tool 204, regardless of whether the source code file has been checked out as read-only or modifiable, the filtering mechanism 210 reformats the source code of the selected source code file. Specifically, the filtering mechanism 210 reformats the selected source code file from the appearance format in accordance within which the source code file is currently formatted, to the desired appearance format 208. The desired appearance format 208 may be specified in a preferences file, and/or the source code repository 202, the software development tool 204 and/or the filtering mechanism 210 may provide a way by which a user is able to specify the desired appearance format 208. The programmer who had requested the checking out of this source code file is thus able to view, and optionally modify, the source code of the source code file in accordance with the desired appearance format 208. The programmer may not even be aware that the source code file was formatted in accordance with a different appearance format, since the reformatting is performed by the filtering mechanism 210 automatically upon checking out of the source code file from the source code repository 202 into the software development tool 204.

Once the programmer has finished viewing or modifying the selected source code file, he or she checks the source code file back into the source code repository 202, through the source development tool 204. Therefore, the filtering mechanism 210 reformats the source code of the selected source code file, particularly in the case where the source code file was checked out as modifiable. Specifically, the filtering mechanism 210 reformats the selected source code file from the desired appearance format 208, to the appearance format in which the source code file was formatted when the source code file was originally checked out.

As such, the filtering mechanism 210 can in one embodiment store or otherwise remember the original appearance format for the source code file when the source code file is checked out from the source code repository 202. In other embodiments, the source code repository 202 has a standard appearance format in which it stores source code files, such that the filtering mechanism 210 does not need to store or otherwise remember the original appearance format for a source code file when it is checked out. The standard appearance format may be user-configurable, and may apply to a given source code project or grouping of source code files stored within the repository 202.

The source code repository 202 can store the source code files 206 all in the same appearance format if desired, which may be particular to the source code repository 202 while programmers can still view and modify the source code files 206 in a different, user-defined format. Furthermore, a programmer may create a new source code file within the software development tool 204 that will be stored in the source code repository 202. In such situations, the filtering mechanism 210 can in one embodiment reformat the appearance format of the new source code file from the desired appearance format 208 to the standard appearance format used in storage of the source code files 206 within the source code repository 202.

In FIG. 3, the filtering mechanism 210 is separate from and independent of the software development tool 204, in contradistinction to FIG. 2. That is, in the embodiment of FIG. 2, the filtering mechanism 210 is integrated with and part of the software development tool 204, whereas in the embodiment of FIG. 3, it is separate from and independent of the software development tool 204 It is noted that in another embodiment, the filtering mechanism 210 may be part of the source code repository 202. The filtering mechanism 210 operates substantially the same in FIGS. 2 and 3, regardless of where it is located, with at least one exception, as is now described.

A programmer checks out the source code files 206 from the source code repository 202 through the software development tool 204. In so doing, the programmer may check out a selected source code file as either read-only or modifiable. However, if the selected source code file is checked out as read-only, then the filtering mechanism 210 cannot automatically reformat the source code file in the embodiment of FIG. 3. This is because the selected source code file is earmarked as being read-only, and thus is not able to be modified, but reformatting the source code file inherently requires that the source code file be changed.

Therefore, the filtering mechanism 210 first determines whether the selected source code file being checked out from the source code repository 202 has been checked out as read-only. If so, then the filtering mechanism 210 temporarily changes the source code file so that it is modifiable, and not read-only, in order for the filtering mechanism 210 to be able to reformat the file from its current appearance format to the desired appearance format 208. After performing this reformatting, the filtering mechanism 210 changes the source code file back to being read-only, and passes the file to the software development tool 204, where it can be viewed, but not modified, by the programmer.

It is noted that this embodiment of FIG. 3 differs from the embodiment of FIG. 2. In the embodiment of FIG. 2, because the filtering mechanism 210 is tightly integrated with and part of the software development tool 204, it does not have to temporarily change a selected source code file that has been checked out as read-only to instead be modifiable, so that reformatting can be accomplished. Furthermore, where the filtering mechanism 210 is integrated with and part of the source code repository 202, it similarly does not have to temporarily change a selected source code file that has been checked out as read-only to instead be modifiable. However, in another embodiment, the filtering mechanism 210 may still have to temporarily change a selected source code file that has been checked out as read-only to instead be modifiable, even where the mechanism 210 is integrated with and part of the software development tool 204 or the source code repository 202.

Detailed Method

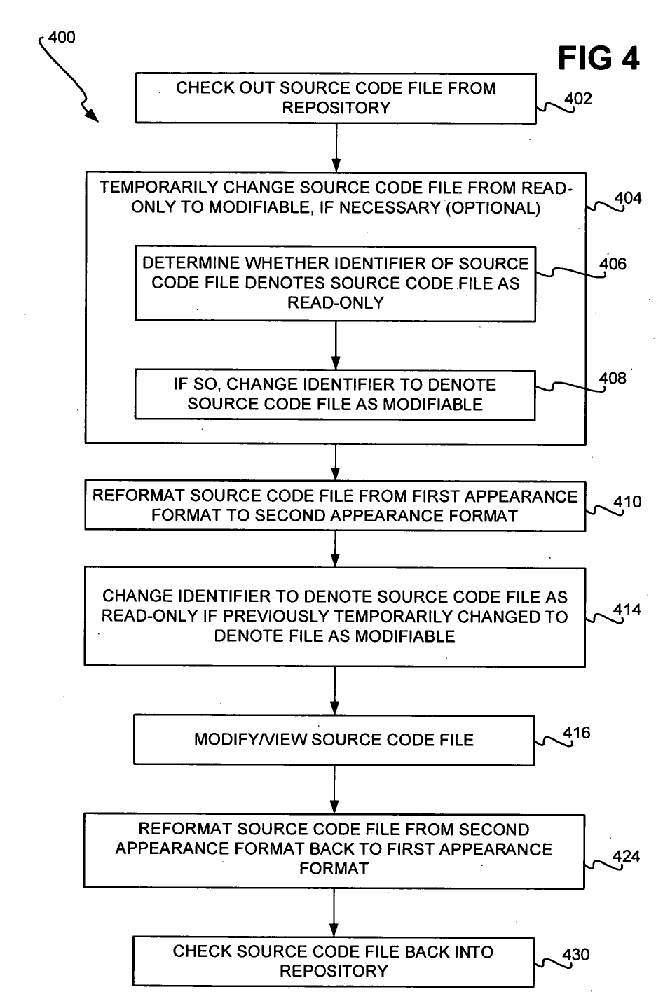

FIG. 4 shows a method 400 for reformatting a source code file from one appearance format, or code style, to another appearance format, or code style, according to an embodiment of the invention. The method 400 may be performed by or in relation to the system 200 of FIGS. 2 and/or 3. That is, different parts of the method 400 may be performed by or in conjunction with the source code repository 202, the software development tool 204, and/or the filtering mechanism 210 of the system 200 in one embodiment of the invention. Furthermore, the method 400 is particularly described in relation to the system 200, but may be performed not in relation to the system 200, too.

A source code file, selected from the source code files 206, is checked out from the source code repository 202 (402). In one embodiment, the source code file may be temporarily changed from read-only to modifiable (404), such as in the embodiment of the system 200 of FIG. 3, where the filtering mechanism 210 is a stand-alone mechanism. In such instance, the filtering mechanism 210 in one embodiment determines whether an identifier, such as a flag, of the source code file denotes the file as read-only (406). If so, the filtering mechanism 210 changes the identifier to denote the source code file as modifiable (408). If the identifier of the source code file already denotes the file as modifiable, then this change does not need to be made.

The source code file is then reformatted by the filtering mechanism 210 from a first appearance format to a second appearance format (410). The first appearance format may be the appearance format in which the source code file is stored in the source code repository 202, such that all source code files of a given type or group are stored in the source code repository 202 with this same, standard appearance format. Alternatively, the source code file may itself not have consistent formatting throughout the source code file. In this embodiment, the first appearance format is the initial appearance of the source code file, where the source code file has been formatted in a number of different coding styles. The second appearance format may be the desired appearance format 208 in accordance with which a programmer wishes to view source code files generally.

Reformatting of the source code file, as has been described, involves changing one or more appearance-related aspects of the source code file, all without substantively changing the source code file. The spacing of the source code file may be changed. The maximum line length of the source code file may also be changed. The placement of opening and closing braces within the source code file may be changed. How color is used in the source code file may further be changed. Other appearance-related aspects of the source code file may be changed in reformatting the source code file, too.

If the filtering mechanism 210 had previously temporarily changed the source code file to modifiable from read-only, then the mechanism 210 changes the source code file back to read-only, such as by changing the identifier to denote the file as read-only (414). A programmer is now able to view and/or modify the source code file within the software development tool 204 (416). At some point, the programmer is finished viewing and/or modifying the source code file, and therefore indicates to the software development tool 204 that the source code file should be checked back into the source code repository 202.

The source code file is then reformatted by the filtering mechanism 210 from the second appearance format back to the first or original appearance format, particularly in the case where the source code file was checked out as modifiable (424). The first appearance format, as has been described, may be a standard appearance format in which all source code files of a given type or group may be stored in the source code repository 202. The source code file is then checked back into the source code repository 202 (430). Any locally stored copies of the source code file may remain even after the source code file has been checked back into the source code repository 202. Such locally stored copies of the source code file remain in the second appearance format.

Conclusion

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
upon a source code file being checked out from a source code repository, reformatting the source code file from a first appearance format to a second appearance format, such that source code of the source code file remains substantively unchanged; and,
upon the source code file being checked back into the source code repository, reformatting the source code file from the second appearance format back to the first appearance format, such that the source code of the source code file remains substantively unchanged.

2. The method of claim 1, wherein the source code of the source code file remaining substantively unchanged comprises the source code file being compilable into identical compiled code independent of whether the source code file is in the first appearance format or the second appearance format.

3. The method of claim 1, further comprising, upon the source code file being checked out from the source code repository:
before reformatting the source code file from the first appearance format to the second appearance format,
determining whether an identifier of the source code file denotes the source code file as read-only;
where the identifier denotes the source code file as read-only, changing the identifier so that the source code file is denoted as modifiable; and,
after reformatting the source code file from the first appearance format to the second appearance format,
where the identifier has been changed so that the source code file is denoted as modifiable, changing the identifier back so that the source code file is again denoted as read-only.

4. The method of claim 1, wherein reformatting the source code file from the first appearance format to the second appearance format and from the second appearance format back to the first appearance format comprises at least one of:
changing spacing of the source code file without substantively changing the source code file;
changing a maximum line length of the source code file without substantively changing the source code file;
changing placement of opening and closing braces within the source code file without substantively changing the source code file; and,
changing how color is used in the source code file without substantively changing the source code file.

5. The method of claim 1, wherein the source code file being checked out from the source code repository comprises a user checking out the source code file from the source code repository to a software development tool.

6. The method of claim 5, wherein reformatting the source code file from the first appearance format to the second appearance format and from the second appearance format back to the first appearance format is performed by the software development tool.

7. The method of claim 5, wherein reformatting the source code file from the first appearance format to the second appearance format and from the second appearance format back to the first appearance format is performed by a stand-alone filtering mechanism separate from the software development tool.

8. The method of claim 1, wherein the first appearance format of the source code file is particular to all source code files of a specific type and stored in the source code repository, and the second appearance format of the source code file is user-defined.

9. The method of claim 1, wherein the first appearance format encompasses multiple coding styles in relation to which the source code file was initially formatted.

10. A system comprising:
a source code repository to store one or more source code files;
one or more software development tools, each software development tool capable of checking out the source code files from and checking the source code files back into the source code repository; and,
a filtering mechanism to reformat the source code files from a first appearance format to a second appearance format upon the source code files being checked out from the source code repository, and to reformat the source code files from the second appearance format back to the first appearance format upon the source code files being checked back into the source code repository.

11. The system of claim 10, wherein the filtering mechanism is part of and integrated with the software development tools.

12. The system of claim 10, wherein the filtering mechanism is a stand-alone mechanism separate from the software development tools.

13. The system of claim 10, wherein the filtering mechanism is part of the source code repository.

14. The system of claim 10, wherein the filtering mechanism, prior to reformatting the source code files, upon determining that identifiers of the source code files denote the source code files as read-only, temporarily changes the identifiers of the source code files to denote the source code files as modifiable in order to reformat the source code files.

15. The system of claim 10, wherein the first appearance format is particular to the source code repository, and the second appearance format is user-defined.

16. An article of manufacture comprising:
a computer-readable medium; and,
means in the medium for reformatting a source code file from a first appearance format to a second appearance format upon the source code file being checked out from a source code repository, and for reformatting the source code file from the second appearance format back to the first appearance format upon the source code file being checked back into the source code repository.

17. The article of claim 16, wherein the means is further for determining whether an identifier of the source code file denotes the source code file as read-only, and for changing temporarily the identifier to denote the source code file as modifiable upon determining that the identifier denotes the source code file as read-only.

18. The article of claim 16, wherein the first appearance format is particular to the source code repository, and the second appearance format is user-defined.

19. The article of claim 16, wherein the first appearance format encompasses multiple coding styles in relation to which the source code file was initially formatted.
